(19) United States
(12) Patent Application Publication
(10) Pub. No.: US 2026/0128061 A1
(43) Pub. Date: May 7, 2026

(54) MAGNETIC RECORDING MEDIUM, METHOD OF MANUFACTURING MAGNETIC RECORDING MEDIUM, AND MAGNETIC STORAGE DEVICE

(71) Applicant: Resonac Hard Disk Corporation, Chiba (JP)

(72) Inventors: Takayuki FUKUSHIMA, Chiba (JP); Masaru TAJIMA, Chiba (JP)

(21) Appl. No.: 19/370,341

(22) Filed: Oct. 27, 2025

(30) Foreign Application Priority Data
Nov. 1, 2024 (JP) 2024-193165

(51) Int. Cl. G11B 5/66; G11B 5/851

(52) U.S. Cl. CPC G11B 5/672; G11B 5/851

(57) ABSTRACT

A magnetic recording medium includes, in a following order, a substrate, an underlayer, a first magnetic layer, and a second magnetic layer, wherein the first magnetic layer includes a magnetic particle having an L1₀ structure, the second magnetic layer has a granular structure including a magnetic particle having an L1₀ structure, and a grain boundary including hexagonal boron nitride, a (111) plane of the magnetic particle included in the first magnetic layer is covered with an alloy of VN, Si₃N₄, YN, or TiN at an interface with the second magnetic layer, the magnetic particle in the second magnetic layer epitaxially grows from a (001) plane of the magnetic particle in the first magnetic layer, and the magnetic particle in the first magnetic layer and the magnetic particle in the second magnetic layer are columnar crystals that penetrate the first magnetic layer and the second magnetic layer, respectively.

### CROSS-REFERENCE TO RELATED APPLICATION

The present application is based on and claims priority to Japanese patent application No. 2024-193165 filed on Nov. 1, 2024, with the Japan Patent Office, the entire contents of which are hereby incorporated by reference.

### BACKGROUND OF THE INVENTION

### 1. Field of the Invention

The disclosures herein relate to magnetic recording media, methods of manufacturing magnetic recording media, and magnetic storage devices.

### 2. Description of the Related Art

In recent years, a heat-assisted recording system or a microwave-assisted recording system, in which a magnetic recording medium is locally heated by irradiation with near-field light or microwaves to reduce coercive force, has attracted attention as a next-generation recording system capable of achieving a high areal density of approximately 2 Tbit/inch².

A magnetic head of such an assisted recording system enables easy recording on a magnetic recording medium having a coercive force of several tens of kOe at room temperature. As magnetic particles included in a magnetic layer of the magnetic recording medium, for example, magnetic particles having a high magnetocrystalline anisotropy constant (Ku) are used. Magnetic particles having a high magnetocrystalline anisotropy constant (Ku) can be reduced in size while maintaining thermal stability, which increase the coercive force at room temperature.

As magnetic particles having a high magnetocrystalline anisotropy constant (Ku), for example, magnetic particles having an L1₀ structure such as Fe—Pt alloy particles (Ku: maximum 7×10⁶ J/m³) and Co—Pt alloy particles (Ku: maximum 5×10⁶ J/m³) are known.

As a magnetic layer using magnetic particles having an L1₀ structure, for example, Non-Patent Literature 1 discloses a magnetic layer having a granular structure in which FePt magnetic particles having an L1₀ structure are covered with layers of hexagonal boron nitride.

Here, it is desired to further improve areal density of a magnetic recording medium. In order to further improve the areal density of the magnetic recording medium, it is important to further reduce a particle size of the magnetic particles included in the magnetic layer and further increase anisotropy of the magnetic particles.

As such a magnetic layer, a magnetic layer having a granular structure including FePt magnetic particles oriented in a (001) direction with an L1₀ structure and hexagonal boron nitride in grain boundaries (hereinafter, simply referred to as “FePt-hBN granular magnetic layer”) has been proposed.

The hexagonal boron nitride has a layered structure in which (001) planes are stacked in parallel. Since hexagonal boron nitride tends to form grain boundaries between the FePt magnetic particles, particle size of the FePt magnetic particles can be reduced. In addition, since hexagonal boron nitride has low reactivity with the FePt magnetic particles, it does not hinder ordering of the magnetic particles. It is preferable to form hexagonal boron nitride such that the (001) plane surrounds the lateral surfaces of the FePt magnetic particles.

However, in the related art, the magnetic particles and the grain boundaries tend to form a layered structure separated from each other, and the granular structure tends not to be formed in the FePt-hBN granular magnetic layer. In addition, components of the grain boundaries such as BN tend not to be sufficiently crystallized and tend to be in an amorphous state. Therefore, even if a magnetic layer (also referred to as a granular magnetic layer) having a granular structure is used, the areal density of the magnetic recording medium may not be improved.

One aspect of the present disclosure aims to provide a magnetic recording medium in which the areal density is further improved by stably maintaining a state in which the granular magnetic layer forms a granular structure inside.

### CITATION LIST

### Non-Patent Literature

[Non-Patent Literature 1] B. S. D. Ch. S. Varaprasad et al., “FePt—BN granular HAMR media with high grain aspect ratio and high L1 ordering on Corning Lotus™ NXT glass”, AIP Advances, Volume 13, Issue 3, 035002 (2023)

### SUMMARY OF THE INVENTION

The above object can be achieved by the following.

(1) A magnetic recording medium including, in a following order:
a substrate;
an underlayer;
a first magnetic layer; and
a second magnetic layer, wherein:
the first magnetic layer includes a magnetic particle having an L1₀ structure;
the second magnetic layer has a granular structure including:
   a magnetic particle having an L1₀ structure; and
   a grain boundary including hexagonal boron nitride;
a (111) plane of the magnetic particle included in the first magnetic layer is covered with an alloy of VN, Si₃N₄, YN, or TiN at an interface with the second magnetic layer;
the magnetic particle included in the second magnetic layer epitaxially grows from a (001) plane of the magnetic particle included in the first magnetic layer; and
the magnetic particle included in the first magnetic layer and the magnetic particle included in the second magnetic layer are columnar crystals that penetrate the first magnetic layer and the second magnetic layer, respectively.

(2) The magnetic recording medium according to (1), wherein the magnetic particle having the L1₀ structure included in the first magnetic layer and the magnetic particle having the L1₀ structure included in the second magnetic layer are FePt alloy particles.

(3) A method of manufacturing a magnetic recording medium, the magnetic recording medium including, in a following order, a substrate, an underlayer, a first magnetic layer, and a second magnetic layer, wherein:
the first magnetic layer includes a magnetic particle having an L1₀ structure;
the second magnetic layer has a granular structure including:
   a magnetic particle having an L1₀ structure; and
   a grain boundary including hexagonal boron nitride;
a (111) plane of the magnetic particle included in the first magnetic layer is covered with an alloy of VN, Si₃N₄, YN, or TiN at an interface with the second magnetic layer;
the magnetic particle included in the second magnetic layer epitaxially grows from a (001) plane of the magnetic particle included in the first magnetic layer; and
the magnetic particle included in the first magnetic layer and the magnetic particle included in the second magnetic layer are columnar crystals that penetrate the first magnetic layer and the second magnetic layer, respectively,
the method including:
forming the first magnetic layer by sputtering;
forming the second magnetic layer by sputtering; and
forming, by sputtering, an alloy layer of VN, Si₃N₄, YN, or TiN between the forming the first magnetic layer and the forming the second magnetic layer.

(4) A magnetic storage device including a magnetic recording medium, the magnetic recording medium including, in a following order, a substrate, an underlayer, a first magnetic layer, and a second magnetic layer, wherein:
the first magnetic layer includes a magnetic particle having an L1₀ structure;
the second magnetic layer has a granular structure including:
   a magnetic particle having an L1₀ structure; and
   a grain boundary including hexagonal boron nitride;
a (111) plane of the magnetic particle included in the first magnetic layer is covered with an alloy of VN, Si₃N₄, YN, or TiN at an interface with the second magnetic layer;
the magnetic particle included in the second magnetic layer epitaxially grows from a (001) plane of the magnetic particle included in the first magnetic layer; and
the magnetic particle included in the first magnetic layer and the magnetic particle included in the second magnetic layer are columnar crystals that penetrate the first magnetic layer and the second magnetic layer, respectively.

According to one clause of the present disclosure, it is possible to provide a magnetic recording medium in which a granular magnetic layer stably maintains a state in which a granular structure is formed inside and areal density is further improved.

According to another clause of the present disclosure, it is possible to provide a method of manufacturing a magnetic recording medium in which a granular magnetic layer stably maintains a state in which a granular structure is formed inside and areal density is further improved.

According to further another clause of the present disclosure, it is possible to provide a magnetic storage device having a high recording capacity.

### BRIEF DESCRIPTION OF THE DRAWINGS

FIG. 1 is a cross-sectional view illustrating an example of a layer configuration of a magnetic recording medium according to an embodiment of the present disclosure;

FIG. 2A is a schematic cross-sectional view illustrating crystal growth during formation of a first magnetic layer and a second magnetic layer according to the related art;

FIG. 2B is a schematic cross-sectional view illustrating crystal growth during formation of the first magnetic layer and the second magnetic layer according to the present disclosure;

FIG. 3 is a perspective view illustrating an example of a magnetic storage device according to the present disclosure; and

FIG. 4 is a schematic view illustrating a magnetic head of FIG. 3.

### DESCRIPTION OF THE PREFERRED EMBODIMENTS

In the following, embodiments of the present invention will be described with reference to the accompanying drawings. In the drawings used in the following description, characteristic portions may be enlarged for convenience in order to facilitate understanding the characteristics, and the dimensional ratio of each component may not be the same. In addition, in the present disclosure, “to” indicating a numerical range means that the numerical values before and after “to” are inclusive as the lower and upper limits, unless otherwise specified. In such a numerical range, if only the upper limit is expressed with units, the lower limit is understood to be expressed in the same units.

### [Magnetic Recording Medium]

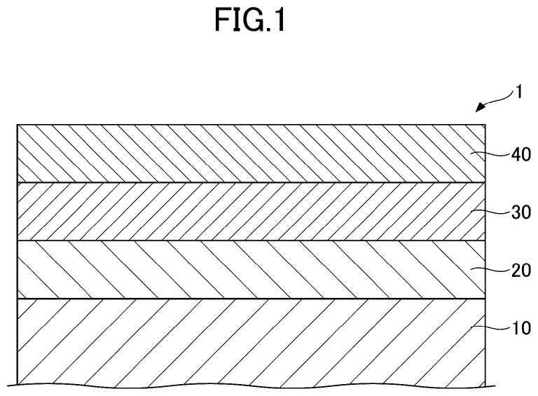

FIG. 1 is a cross-sectional view illustrating an example of a layer configuration of a magnetic recording medium according to an embodiment of the present disclosure (hereinafter, also referred to as “the present embodiment”). As shown in FIG. 1, the magnetic recording medium 1 includes a substrate 10, an underlayer 20, a first magnetic layer 30, and a second magnetic layer 40 stacked in this order.

The substrate 10 may be a substrate generally used for the magnetic recording medium 1. As the substrate 10, it is preferable to use, for example, a heat-resistant glass substrate having a softening temperature of 500° C. or higher, preferably 600° C. or higher. When the magnetic recording medium 1 is manufactured, the substrate 10 may be heated to a temperature of 500° C. or more.

A material included in the underlayer 20 is not particularly limited as long as magnetic particles having an L1₀ structure included in the first magnetic layer 30 and the second magnetic layer 40 can be oriented in the (001) plane.

The underlayer 20 may have a multilayer structure.

The underlayer 20 preferably includes a NaCl type compound.

Examples of the NaCl type compound include MgO, TiO, NiO, TiN, TaN, HEN, NbN, ZrC, HfC, TaC, NbC, or TiC. One of them may be used alone, or two or more of them may be used in combination.

The first magnetic layer 30 includes magnetic particles having the L1₀ structure.

Examples of the magnetic particles in the first magnetic layer 30 and having the L1₀ structure include FePt alloy particles and CoPt alloy particles. The FePt alloy particles and the CoPt alloy particles are magnetic particles having the L1₀ structure and oriented in the (001) direction.

The magnetic particles included in the first magnetic layer 30 are columnar crystals having a shape penetrating the first magnetic layer 30.

Particle size of the magnetic particles included in the first magnetic layer 30 is not particularly limited as long as they are columnar, and may be, for example, 3 to 7 nm in equivalent circle diameter. The particle size of the magnetic particles included in the first magnetic layer 30 may be an average particle size of the magnetic particles measured by observation with a plane-view transmission electron microscope. When a magnetic particle is a spherical particle, the diameter of the magnetic particle is used, when a magnetic particle is an elliptical particle, the intermediate value between the short and long diameters of the magnetic particle is used, and when a magnetic particle is an amorphous particle, the intermediate value between the short and long sides of the magnetic particle is used to determine the particle size. The determined particle sizes are used to generate a particle size distribution of the magnetic particles. The average value of the particle sizes determined based on the generated particle size distribution may be used as the average particle size.

An aspect ratio of the magnetic particles included in the first magnetic layer 30 depends on a thickness of the first magnetic layer 30. When a height of a magnetic particle is referred to as t and an equivalent circle diameter is referred to as D, an aspect ratio (t/D) of the magnetic particle may be, for example, 0.1 to 1.5. The aspect ratio is a value obtained by dividing the longest axis of the magnetic particle by the shortest axis of the magnetic particle. The aspect ratio of the magnetic particles is obtained by dividing the particle height measured by cross-sectional transmission electron microscope observation by the average particle size measured by plane-view transmission electron microscope observation.

A center distance between the magnetic particles included in the first magnetic layer 30 is preferably 4.0 to 9.0 nm. The center distance between the magnetic particles included in the first magnetic layer 30 is more preferably 8.8 nm or less, and further more preferably 8.6 nm or less. When the center distance between the magnetic particles included in the first magnetic layer 30 is within the above preferred range, magnetic particles having a small particle size can be included in the first magnetic layer 30.

The center distance between the magnetic particles refers to a distance between centers of gravity of adjacent magnetic particles. The center distance between the magnetic particles can be measured, for example, by calculating the center distance between the centers of gravity of adjacent magnetic particles from a surface observation image obtained by a scanning electron microscope (SEM).

The second magnetic layer 40 is a granular magnetic layer including magnetic particles having an L1₀ structure and grain boundaries. The grain boundaries include hexagonal boron nitride and are also referred to as hexagonal boron nitride grain boundaries.

Examples of the magnetic particles in the second magnetic layer 40 and having the L1₀ structure include FePt alloy particles and CoPt alloy particles.

Similar to the magnetic particles included in the first magnetic layer 30, the magnetic particles included in the second magnetic layer 40 are columnar crystals having a shape penetrating the second magnetic layer 40.

Similar to the magnetic particles included in the first magnetic layer 30, the particle size of the magnetic particles included in the second magnetic layer 40 is not particularly limited as long as they are columnar, and may be, for example, 3 to 7 nm in equivalent circle diameter. The average particle size of the magnetic particles included in the second magnetic layer 40 can be measured in the same manner as the magnetic particles included in the first magnetic layer 30.

Similar to the magnetic particles included in the first magnetic layer 30, the aspect ratio of the magnetic particles included the second magnetic layer 40 depends on the thickness of the second magnetic layer 40. The aspect ratio of the magnetic particle may be, for example, 1.2 to 2.5. When a height of the magnetic particle is referred to as t and an equivalent circle diameter is referred to as D, the aspect ratio of the magnetic particle is obtained by t/D. The aspect ratio of the magnetic particles included in the second magnetic layer 40 can be measured by the same method as the method for measuring the aspect ratio of the magnetic particles included in the first magnetic layer 30.

The hexagonal boron nitride included in the grain boundaries has a layered structure in which (001) planes are stacked substantially in parallel. Since hexagonal boron nitride tends to form grain boundaries between the magnetic particles included in the second magnetic layer 40, particle size of the magnetic particles included in the second magnetic layer 40 can be reduced. Furthermore, since hexagonal boron nitride has low reactivity with the magnetic particles having the L1₀ structure, it does not hinder ordering of the magnetic particles included in the second magnetic layer 40. Therefore, it is preferable to form the hexagonal boron nitride such that the (001) planes of the hexagonal boron nitride surround the lateral surfaces of the magnetic particles included in the second magnetic layer 40.

In the related method, it has been difficult to stably form such a granular magnetic layer. That is, since the reactivity of the magnetic alloy and the boron nitride is low, the magnetic alloy and the boron nitride become a layered product separated from each other during film formation, and the granular structure is not formed in many cases. In addition, the boron nitride becomes amorphous without crystallization in many cases.

The inventors of the present disclosure have found that the granular structure of the second magnetic layer 40 can be stably formed by providing the magnetic layer with a two-layer structure of the first magnetic layer 30 and the second magnetic layer 40 stacked on the side of the substrate 10, and by epitaxially growing the magnetic particles of the second magnetic layer 40 from the magnetic particles of the first magnetic layer 30.

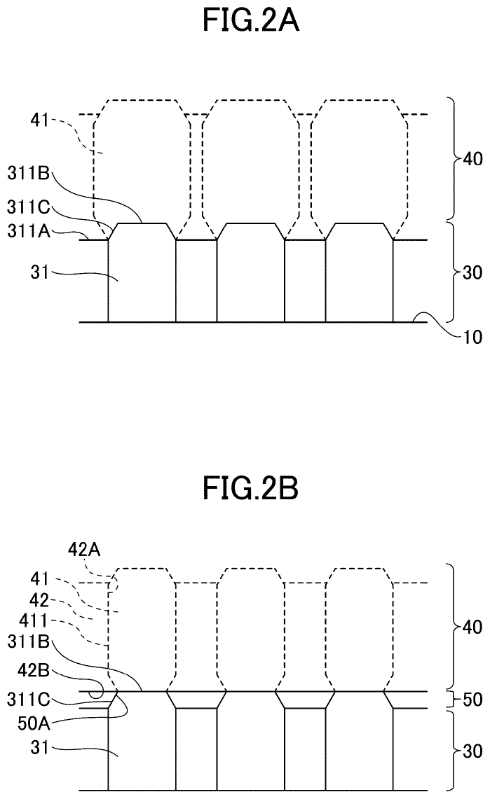

In this case, since the magnetic particles on a growth plane of the first magnetic layer 30 form a (111) plane in addition to the (001) plane, crystal growth proceeds in a direction perpendicular to the (111) plane during film formation of the second magnetic layer 40, and the magnetic particles of the second magnetic layer 40 coarsen. In order to prevent coarsening of the magnetic particles of the second magnetic layer 40, in the present embodiment, the (111) plane of the first magnetic layer 30 is coated with an alloy including a nitride of VN, Si₃N₄, YN, or TiN, so that the coarsening of the magnetic particles of the second magnetic layer 40 can be reduced. This point will be described in detail with reference to FIGS. 2A and 2B.

FIG. 2A is a schematic cross-sectional view illustrating crystal growth during formation of the first magnetic layer 30 and the second magnetic layer 40 according to the related art. FIG. 2B is a schematic cross-sectional view illustrating crystal growth during formation of the first magnetic layer 30 and the second magnetic layer 40 according to the present disclosure. As shown in FIG. 2A, a (001) plane 311B parallel to the substrate 10 and a (111) plane 311C inclined by approximately 35° toward a growth plane 311A (bottom direction in FIGS. 2A and 2B) with respect to the (001) plane 311B are formed on the growth plane 311A of a magnetic particle 31 in the first magnetic layer 30 having the L1₀ structure formed on the substrate 10. When the second magnetic layer 40 (broken lines) is formed on the (111) plane 311C, the magnetic particle 41 of the second magnetic layer 40 also grows in the direction perpendicular to the (111) plane 311C of the magnetic particle 31, so that the particle size of the magnetic particle 41 becomes coarser.

Conversely, in the present embodiment, as shown in FIG. 2B, the (111) plane 311C of the magnetic particle 31 of the first magnetic layer 30 is coated with a layer 50 of an alloy of VN, Si₃N₄, YN, or TiN. Thus, coarsening of the magnetic particle 41 of the second magnetic layer 40 (broken line) is reduced, and the magnetic particle 41 of the second magnetic layer 40 is caused to grow epitaxially on the (001) plane 311B of the magnetic particle 31 of the first magnetic layer 30 to form columnar crystals such that the magnetic particles 31 and 41 penetrate the first magnetic layer 30 and the second magnetic layer 40, respectively. Thus, the magnetic particles 31 and 41 can maintain a fine particle size.

In the present embodiment, the layer 50 of the alloy of VN, Si₃N₄, YN, or TiN is a layer including an alloy including a nitride of VN, Si₃N₄, YN, or TiN, preferably including 50 atom % or more of the alloy of VN, Si₃N₄, YN, or TiN, and most preferably composed of only an alloy of VN, Si₃N₄, YN, or TiN. Further, the layer 50 of the alloy of VN, Si₃N₄, YN, or TiN is not a continuous film, but a film partially penetrated between the magnetic particle 31 and the magnetic particle 41.

The hexagonal boron nitride grain boundary 42 of the second magnetic layer 40 includes hexagonal boron nitride, preferably including 50 atom % or more of hexagonal boron nitride, and most preferably composed of only hexagonal boron nitride.

The content of the hexagonal boron nitride grain boundary 42 in the second magnetic layer 40 is preferably within a range of 25 to 50 vol %, and more preferably within the range of 35 to 45 vol %. When the content of the hexagonal boron nitride grain boundary 42 in the second magnetic layer 40 is within the range of 25 to 50 vol %, the coercive force Hc of the magnetic recording medium 1 and anisotropy of the magnetic particles 31 and 41 included in the first magnetic layer 30 and the second magnetic layer 40 can be enhanced.

The method for measuring the content of the hexagonal boron nitride grain boundary 42 in the second magnetic layer 40 is not particularly limited, and a general method for measuring volume in particles can be used, but it can be determined, for example, by elemental analysis of the grain boundaries by TEM-EELS.

In the present embodiment, the first magnetic layer 30 may also have a granular structure like the second magnetic layer 40. In this case, the content of the grain boundaries in the first magnetic layer 30 may be the same as that in the second magnetic layer 40.

### [Method of Manufacturing Magnetic Recording Medium]

An example of a method of manufacturing a magnetic recording medium 1 will be described. A method for manufacturing a magnetic recording medium 1 includes a step of forming a first magnetic layer 30 by sputtering, a step of forming a layer 50 of the alloy of VN, Si₃N₄, YN, or TiN by sputtering the alloy of VN, Si₃N₄, YN, or TiN on a main surface of the first magnetic layer 30, and a step of forming a second magnetic layer 40 by sputtering on the main surface of a layer 50 of the alloy of VN, Si₃N₄, YN, or TiN. That is, the magnetic recording medium 1 is manufactured by including a step of forming a layer 50 of the alloy of VN, Si₃N₄, YN, or TiN by sputtering between a step of forming the first magnetic layer 30 by sputtering and a step of forming the second magnetic layer 40 by sputtering, so that a layer 50 of the alloy of VN, Si₃N₄, YN, or TiN is provided between the first magnetic layer 30 and the second magnetic layer 40. By using such a manufacturing method, the (111) plane 311C of the magnetic particle 31 on the growth plane of the first magnetic layer 30 can be coated with the layer 50 of the alloy of VN, Si₃N₄, YN, or TiN, and coarsening of the magnetic particle 41 of the second magnetic layer 40 can be reduced.

Such a method of forming a film includes, for example, a method of using a discharge gas pressure of 2 Pa or less, using RF discharge, setting a target surface potential to 50 to 200 V, and heating (post-annealing) after film-forming so that the post-annealing temperature is higher than the film forming temperature by approximately 100° C. The gas atmosphere may be an inert gas atmosphere such as nitrogen or argon.

Further, after forming a layer 50 of the alloy of VN, Si₃N₄, YN, or TiN so as to coat the entire surface of the magnetic particle 31, the surface of the magnetic particle 31 may be etched to remove only the alloy of VN, Si₃N₄, YN, or TiN deposited on the (001) plane 311B of the magnetic particle 31, so that the alloy of VN, Si₃N₄, YN, or TiN coats only the (111) plane 311C and the layer 50 of the alloy of VN, Si₃N₄, YN, or TiN is provided only on the (111) plane 311C.

On an etching surface of the alloy of VN, Si₃N₄, YN, or TiN, nitrogen included in the alloy of VN, Si₃N₄, YN, or TiN is readily separated, which has the effect of compensating for nitrogen deficiency in the hexagonal boron nitride grain boundary 42 of the second magnetic layer 40 formed subsequently. Therefore, a position of a peak obtained when the hexagonal boron nitride grain boundary 42 is subjected to chemical composition analysis by X-ray photoelectron spectroscopy (XPS) can be shifted to around 191 eV derived from hexagonal boron nitride which is a nitride. The hexagonal boron nitride grain boundary 42, which has been further nitrided, exhibits improved crystallinity, which facilitates separation of magnetic particles of the hexagonal boron nitride and columnar growth of the hexagonal boron nitride.

In order to form columnar crystals, the magnetic particle 31 included in the first magnetic layer 30 and the magnetic particle 41 included in the second magnetic layer 40 are preferably c-axis oriented with respect to the substrate 10, that is, they are preferably (001) plane oriented.

As a method of c-axis orienting the magnetic particle 31 included in the first magnetic layer 30 and the magnetic particle 41 included in the second magnetic layer 40 with respect to the substrate 10, for example, a method of epitaxially growing the first magnetic layer 30 and the second magnetic layer 40 in a c-axis direction using the underlayer 20 can be mentioned.

Further another magnetic layer may be provided under the first magnetic layer 30 or on the second magnetic layer 40. Like the first magnetic layer 30, another magnetic layer newly provided preferably includes magnetic particles having an L1₀ structure. The magnetic particles preferably form columnar crystals with the magnetic particles 31 and 41.

Therefore, the magnetic recording medium 1 shown in FIG. 1 can be obtained by using the manufacturing method of the magnetic recording medium 1.

The magnetic recording medium 1 preferably further has a protective layer on the first magnetic layer 30 and the second magnetic layer 40.

The protective layer may be, for example, a hard carbon film.

As a method of forming the protective layer, there may be, for example, an RF-CVD (Radio Frequency-Chemical Vapor Deposition) method for forming a film by decomposing a hydrocarbon gas (source gas) with a radio frequency plasma, an IBD (Ion Beam Deposition) method for forming a film by ionizing the source gas with electrons emitted from a filament, and an FCVA (Filtered Cathodic Vacuum Arc) method for forming a film by using a solid carbon target without using a source gas.

The thickness of the protective layer is preferably 1 to 6 nm. When the thickness of the protective layer is 1 nm or more, the floating characteristic of the magnetic head is excellent, and when the thickness is 6 nm or less, the magnetic spacing is reduced, and an SNR (signal/noise ratio, also referred to as S/N ratio) of the magnetic recording medium 1 is improved.

In the present disclosure, a thickness of the protective layer means a length in a direction perpendicular to the main surface of the protective layer. The thickness of the protective layer is, for example, a thickness measured at an arbitrary location in the cross section of the protective layer. When several measurements are made at arbitrary locations in the cross section of the protective layer, an average value of the thicknesses of these measurement locations be used. The same may measurement method as that for the thickness of the protective layer may be used for other layers.

The magnetic recording medium 1 may further include a lubricant layer on the protective layer.

The lubricant layer can be formed by using a liquid lubricant layer. A liquid lubricant having chemical stability, low friction, and low adsorption is preferably used. The liquid lubricant includes, for example, a fluororesin lubricant such as a perfluoropolyether lubricant including a compound having a perfluoropolyether structure.

The thickness of the lubricant layer is not particularly limited, but may be, for example, 1 to 3 nm.

In addition to the protective layer and the lubricant layer, the magnetic recording medium 1 may include an optional layer as appropriate. For example, the magnetic recording medium 1 may include an adhesion layer, a soft magnetic underlayer, an orientation control layer, or the like between layers of the substrate 10, the underlayer 20, and the first magnetic layer 30 as appropriate. The soft magnetic underlayer may include, for example, a first soft magnetic layer, an intermediate layer, and a second soft magnetic layer. The orientation control layer may be one layer or two or more layers (e.g., first orientation control layer, second orientation control layer). The materials for forming the adhesion layer, the soft magnetic underlayer, the orientation control layer, and the like can be general materials used for magnetic recording media.

Thus, the magnetic recording medium 1 has the substrate 10, the underlayer 20, the first magnetic layer 30, and the second magnetic layer 40 in this order, the first magnetic layer 30 includes the magnetic particle 31 having the L1₀ structure, the second magnetic layer 40 is a granular magnetic layer including the magnetic particle 41 having the L1₀ structure and the hexagonal boron nitride grain boundary 42, and the hexagonal boron nitride grain boundary 42 includes hexagonal boron nitride. The (111) plane 311C of the magnetic particle 31 has an interface with the second magnetic layer 40 coated with an alloy of VN, Si₃N₄, YN, or TiN, and the magnetic particle 41 grow epitaxially from the (001) plane 311B of the magnetic particle 31. Further, the magnetic particles 31 and 41 are formed to form columnar crystals respectively penetrating the first magnetic layer 30 and the second magnetic layer 40. Therefore, particle sizes of the magnetic particles 31 and 41 are small and minute, and the magnetic particles 31 and 41 are formed continuously in one direction in a columnar manner.

The magnetic recording medium 1 can increase anisotropy by reducing the particle sizes of the magnetic particles 31 and 41 included in the first magnetic layer 30 and the second magnetic layer 40, respectively, and by including the magnetic particles 31 and 41 in a state of being continuously connected in the same direction. Therefore, the magnetic recording medium 1 can stably maintain a state in which a granular structure is formed inside the second magnetic layer 40 and can stably include the second magnetic layer 40 as a granular magnetic layer, so that the areal density can be further improved.

Since the magnetic recording medium 1 has the above-described characteristics, even if a heat-assisted recording method or a microwave-assisted recording method is used as a recording method, the first magnetic layer 30 and the second magnetic layer 40 have a high recording density, so that magnetic information can be sufficiently recorded on the first magnetic layer 30 and the second magnetic layer 40 by the recording magnetic field of the magnetic head. Therefore, the magnetic recording medium 1 can be suitably used in a magnetic recording and reproducing device having a higher recording density.

### [Magnetic Storage Device]

A magnetic storage device (also referred to as “magnetic recording and reproducing device”) including a magnetic recording medium according to the present embodiment will be described. The configuration of the magnetic storage device according to the present embodiment is not particularly limited as long as it has the magnetic recording medium according to the present embodiment. Here, a case where the magnetic storage device records magnetic information on the magnetic recording medium using a heat-assisted recording method will be described.

The magnetic storage device according to the present embodiment may include, for example, a magnetic recording medium drive unit for driving and rotating the magnetic recording medium according to the present embodiment, a magnetic head having a near-field light generating element provided at a tip portion, a magnetic head drive unit for driving and moving the magnetic head, and a recording and reproducing signal processing system.

The magnetic head is a thermally assisted recording type magnetic head, and includes, for example, a laser light generator for generating laser light and heating the magnetic recording medium, and a waveguide for guiding the laser light generated from the laser light generator to a near-field light generating element.

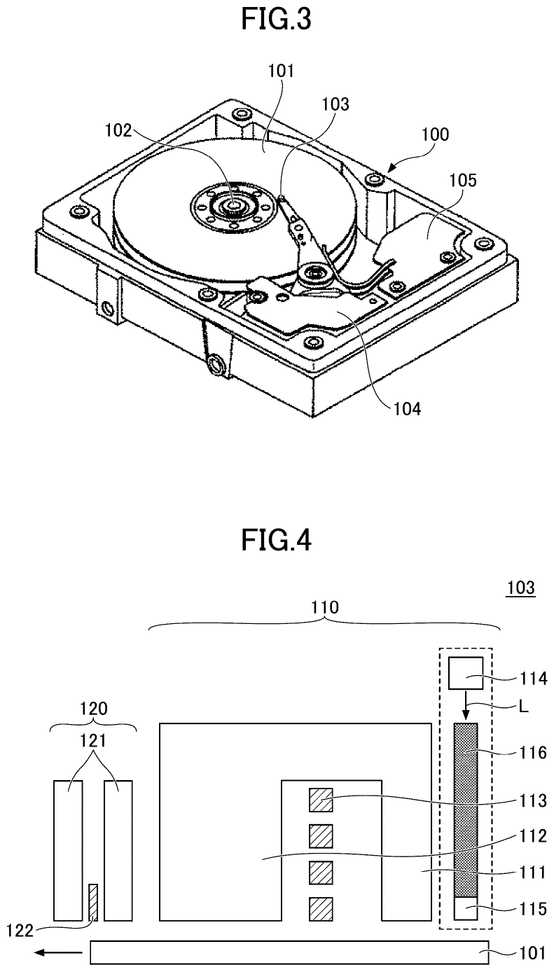

FIG. 3 is a perspective view illustrating an example of a magnetic storage device according to the present embodiment. As shown in FIG. 3, the magnetic storage device 100 may include a magnetic recording medium 101, a magnetic recording medium driver 102 for rotating the magnetic recording medium 101, a magnetic head 103 provided with a near-field light generating element at the tip, a magnetic head driver 104 for moving the magnetic head 103, and a recording and reproducing signal processor 105. The magnetic recording medium 1 described above is used as the magnetic recording medium 101.

FIG. 4 is a schematic view illustrating the magnetic head 103. As shown in FIG. 4, the magnetic head 103 includes a recording head 110 and a reproducing head 120.

The recording head 110 includes a main magnetic pole 111, an auxiliary magnetic pole 112, a coil 113 for generating a magnetic field, a laser diode (LD) 114 for generating a laser beam, and a waveguide 116 for guiding the laser beam L generated from the LD 114 to the near-field light generating element 115.

The reproducing head 120 has a shield 121 and a reproducing element 122 sandwiched by the shield 121.

As shown in FIG. 3, in the magnetic storage device 100, the center of the magnetic recording medium 101 is attached to a rotating shaft of a spindle motor, and information is written or read from the magnetic recording medium 101 while the magnetic head 103 floats and travels on the surface of the magnetic recording medium 101 rotationally driven by the spindle motor.

In the magnetic storage device 100 according to the present embodiment, by using the magnetic recording medium 1 for the magnetic recording medium 101, the areal density of the magnetic recording medium 101 can be increased, and therefore the recording capacity of the magnetic recording medium 101 can be increased.

In the magnetic storage device, a magnetic head of a microwave-assisted recording system may be used for the magnetic head 103 instead of a magnetic head of a heat-assisted recording system.

Further, the present invention is not limited to these embodiments, and various variations and modifications may be made without departing from the scope of the present invention.

### EXAMPLES

Hereinafter, the present embodiment will be described in more detail by showing examples, but the present embodiment is not limited by these examples and comparative examples.

### <Production of Magnetic Recording Medium>

### Example 1

A Cr-50at % Ti alloy layer having a thickness of 100 nm and a Co-27at % Fe-5at % Zr-5at % B alloy layer having a thickness of 30 nm were sequentially formed on a glass substrate by a sputtering method as an underlayer. Next, after heating the glass substrate to 250° C., a Cr layer having a thickness of 10 nm and an MgO layer having a thickness of 5 nm were sequentially formed by a sputtering method. Next, the glass substrate was heated to 450° C., and then a 0.5 nm-thick (Fe-48at % Pt-5at % B) alloy layer (first magnetic layer) was formed by sputtering.

Subsequently, a 0.2 nm-thick VN layer was formed as a coating layer of the (111) plane by RF sputtering. Film-forming conditions were such that target surface potential was 100 V, a film-forming rate was 0.08 nm/sec, and the post-annealing temperature was higher than the film forming temperature by approximately 100° C.

Subsequently, etching was performed in an argon atmosphere of 0.5 Pa at 7 W.

Thus, the (111) planes of the magnetic particles of the first magnetic layer were coated with the VN layer.

Subsequently, a (Fe-49at % Pt)-40 volume % hexagonal boron nitride layer (second magnetic layer) having a thickness of 13 nm was sequentially formed by sputtering. Next, a carbon film having a thickness of 3 nm was formed as a protective layer, and a magnetic recording medium was produced.

Table 1 shows the composition and coating conditions of the first magnetic layer and the composition of the second magnetic layer.

### Examples 2 to 26, Comparative Examples 1 to 12

A magnetic recording medium was produced in the same manner as in Example 1, except that the coating conditions of the first magnetic layer were changed to the coating conditions shown in Table 1.

### <Evaluation of Magnetic Recording Medium>

The magnetic recording medium produced in each Example and each Comparative Example was evaluated. The evaluation was carried out by verifying the coating state of the (111) plane of the magnetic particles in the first magnetic layer by a layer of an alloy of VN, Si₃N₄, YN, or TiN, verifying the crystallinity of hexagonal boron nitride (also referred to as hBN), and measuring the coercive force Hc of the magnetic recording medium and the center distance between the magnetic particles of the first magnetic layer.

(Coating State of (111) Plane of Magnetic Particles in First Magnetic Layer by Layer of Alloy of VN, Si₃N₄, YN, or TiN)

The coating state of the (111) plane of the magnetic particles in the first magnetic layer by a layer of the alloy of VN, Si₃N₄, YN, or TiN was evaluated by observing the cross section of the magnetic recording medium using a transmission electron microscope (HD2300, manufactured by Hitachi High-Tech). When the film thickness of the alloy layer of VN, Si₃N₄, YN, or TiN was not uniform and the magnetic particles were connected to each other, the coating film quality was evaluated as deteriorated.

### (Crystallinity of Hexagonal Boron Nitride)

The crystallinity of hexagonal boron nitride of the first magnetic layer was evaluated by observing the cross section of the magnetic recording medium using a transmission electron microscope (HD2300, manufactured by Hitachi High-Tech), observing lattice fringes, and a position of a peak of an XPS spectrum obtained when chemical composition analysis was performed by XPS. Since lattice fringes can be observed at lattice intervals when a crystalline substance is observed using an electron microscope, the crystallinity of hexagonal boron nitride of the first magnetic layer can be verified by observing the cross section of the magnetic recording medium using a transmission electron microscope, observing lattice fringes, and verifying the position of the peak of the XPS spectrum by XPS. When a peak of 191 eV originating from hexagonal boron nitride is observed in the XPS spectrum, it can be determined that the crystallinity of hexagonal boron nitride is good. When the crystallinity of hexagonal boron nitride is good, it can be evaluated that the state in which a granular structure is formed inside the second magnetic layer is stably maintained and the second magnetic layer functions as a granular magnetic layer.

### (Center Distance Between Magnetic Particles of First Magnetic Layer)

The center distance between magnetic particles of the first magnetic layer was obtained by calculating the center distance (unit: nm) between the centers of gravity of adjacent magnetic particles of the first magnetic layer from a surface observation image obtained by SEM. It can be evaluated that the smaller the center distance between magnetic particles, the smaller the particle size of the magnetic particles. Therefore, it can be evaluated that the smaller the center distance between magnetic particles of the first magnetic layer, the smaller the particle size of the magnetic particles of the first magnetic layer, and the areal density can be improved. It should be noted that the center distance between magnetic particles of the first magnetic layer was evaluated to be satisfactory when the center distance was 9.5 nm or less. When evaluating the particle size of the magnetic particles, argon etching was performed for one minute to remove the carbon protective film on the surface of the magnetic recording medium.

### (Coercive Force Hc of Magnetic Recording Medium)

The coercive force Hc of the magnetic recording medium was evaluated by measuring a Kerr rotation angle (unit: kOe) when the main surface of the magnetic recording medium was irradiated with a laser beam (wavelength: 408 nm) using a superconducting Kerr measuring device (BH-810 HM7, manufactured by NEOARK Corporation). The coercive force Hc reflects the crystallinity of the magnetic particles in the first magnetic layer and the second magnetic layer, and it is considered that the coercive force Hc decreases when the crystal structure of the first magnetic layer and the second magnetic layer is disturbed. Therefore, it can be evaluated that the higher the coercive force Hc is, the higher the crystallinity of the first magnetic layer and the second magnetic layer is, and the areal density can be improved. The coercive force Hc of the magnetic recording medium was evaluated to be satisfactory when it was 32.5 kOe or more.

Table 1 shows the evaluation results of the coating state of the (111) plane of the magnetic particles in the first magnetic layer with any of the layers of VN, Si₃N₄, YN, and TiN and the crystallinity of the hexagonal boron nitride, and the measurement results of the center distance between the magnetic particles in the first magnetic layer and the coercive force Hc of the magnetic recording medium. In Table 1, as the crystallinity of the hexagonal boron nitride, the peak at 191 eV derived from the hexagonal boron nitride is referred to as “hBN peak”.

TABLE 1

| | | | | | | | Characteristics of Magnetic Recording Medium | | | |
|---|---|---|---|---|---|---|---|---|---|---|
| | | | | | | | Coating State | | Center | |
| | | | | | | | of (111) Plane | | Distance | |
| | | | | | | | of Magnetic | | Between | |
| | 1^{st} Magnetic Layer | | | | | | Particle in 1^{st} | | Magnetic | |
| | | Coating Conditions | | | | 2^{nd} | Magnetic Layer by | | Particles | |
| | | | Gas | Film | Etching | Magnetic | Layer of Alloy | | in 1^{st} | |
| | | | Atmosphere | Thickness | Power | Layer | (VN, Si₃N₄, | hBN | Magnetic | Hc |
| | Composition | Coating | (N₂)[Pa] | [nm] | [W] | Composition | YN, or TiN) | Peak | Layer [nm] | [kOe] |
| Example | (Fe-48 at % Pt) | VN | 0 | 0.3 | 7 | (Fe-49 at % Pt)- | Good | Good | 8.9 | 38.5 |
| 1 | | | | | | 40 vol % hBN | | | | |
| Example | (Fe-48 at % Pt) | VN | 0 | 0.4 | 7 | (Fe-49 at % Pt)- | Good | Good | 8.8 | 37.6 |
| 2 | | | | | | 40 vol % hBN | | | | |
| Example | (Fe-48 at % Pt) | VN | 0 | 0.2 | 7 | (Fe-49 at % Pt)- | Good | Good | 8.8 | 37.5 |
| 3 | | | | | | 40 vol % hBN | | | | |
| Example | (Fe-48 at % Pt) | VN | 0 | 0.1 | 7 | (Fe-49 at % Pt)- | Good | Good | 9.0 | 34.3 |
| 4 | | | | | | 40 vol % hBN | | | | |
| Example | (Fe-48 at % Pt) | VN | 2.5 | 0.2 | 7 | (Fe-49 at % Pt)- | Good | Good | 8.8 | 37.8 |
| 5 | | | | | | 40 vol % hBN | | | | |
| Example | (Fe-48 at % Pt) | VN | 2.5 | 0.4 | 7 | (Fe-49 at % Pt)- | Good | Good | 8.8 | 37.7 |
| 6 | | | | | | 40 vol % hBN | | | | |
| Example | (Fe-48 at % Pt) | VN | 2.5 | 0.3 | 7 | (Fe-49 at % Pt)- | Good | Good | 8.9 | 38.5 |
| 7 | | | | | | 40 vol % hBN | | | | |
| Example | (Fe-48 at % Pt) | VN | 2.5 | 0.1 | 7 | (Fe-49 at % Pt)- | Good | Good | 9.0 | 34.5 |
| 8 | | | | | | 40 vol % hBN | | | | |
| Example | (Fe-48 at % Pt) | Si₃N₄ | 0 | 0.3 | 7 | (Fe-49 at % Pt)- | Good | Good | 8.7 | 38.5 |
| 9 | | | | | | 40 vol % hBN | | | | |
| Example | (Fe-48 at % Pt) | Si₃N₄ | 0 | 0.4 | 7 | (Fe-49 at % Pt)- | Good | Good | 8.6 | 40.5 |
| 10 | | | | | | 40 vol % hBN | | | | |
| Example | (Fe-48 at % Pt) | Si₃N₄ | 0 | 0.2 | 7 | (Fe-49 at % Pt)- | Good | Good | 8.7 | 37.3 |
| 11 | | | | | | 40 vol % hBN | | | | |
| Example | (Fe-48 at % Pt) | Si₃N₄ | 0 | 0.1 | 7 | (Fe-49 at % Pt)- | Good | Good | 8.9 | 34.9 |
| 12 | | | | | | 40 vol % hBN | | | | |
| Example | (Fe-48 at % Pt) | Si₃N₄ | 2.5 | 0.2 | 7 | (Fe-49 at % Pt)- | Good | Good | 8.7 | 38.2 |
| 13 | | | | | | 40 vol % hBN | | | | |

TABLE 2

| | | | | | | | Characteristics of Magnetic Recording Medium | | | |
|---|---|---|---|---|---|---|---|---|---|---|
| | | | | | | | Coating State | | Center | |
| | | | | | | | of (111) Plane | | Distance | |
| | | | | | | | of Magnetic | | Between | |
| | 1^{st} Magnetic Layer | | | | | | Particle in 1^{st} | | Magnetic | |
| | | Coating Conditions | | | | 2^{nd} | Magnetic Layer by | | Particles | |
| | | | Gas | Film | Etching | Magnetic | Layer of Alloy | | in 1^{st} | |
| | | | Atmosphere | Thickness | Power | Layer | (VN, Si₃N₄, | hBN | Magnetic | Hc |
| | Composition | Coating | (N₂)[Pa] | [nm] | [W] | Composition | YN, or TiN) | Peak | Layer [nm] | [kOe] |
| Example | (Fe-48 at % Pt) | Si₃N₄ | 2.5 | 0.4 | 7 | (Fe-49 at % Pt)- | Good | Good | 8.5 | 40.6 |
| 14 | | | | | | 40 vol % hBN | | | | |
| Example | (Fe-48 at % Pt) | Si₃N₄ | 2.5 | 0.3 | 7 | (Fe-49 at % Pt)- | Good | Good | 8.7 | 37.0 |
| 15 | | | | | | 40 vol % hBN | | | | |
| Example | (Fe-48 at % Pt) | Si₃N₄ | 2.5 | 0.1 | 7 | (Fe-49 at % Pt)- | Good | Good | 8.9 | 34.2 |
| 16 | | | | | | 40 vol % hBN | | | | |
| Example | (Fe-48 at % Pt) | YN | 0 | 0.2 | 7 | (Fe-49 at % Pt)- | Good | Good | 8.8 | 35.4 |
| 17 | | | | | | 40 vol % hBN | | | | |
| Example | (Fe-48 at % Pt) | YN | 0 | 0.1 | 7 | (Fe-49 at % Pt)- | Good | Good | 8.8 | 35.2 |
| 18 | | | | | | 40 vol % hBN | | | | |
| Example | (Fe-48 at % Pt) | YN | 5 | 0.2 | 7 | (Fe-49 at % Pt)- | Good | Good | 8.6 | 39.9 |
| 19 | | | | | | 40 vol % hBN | | | | |
| Example | (Fe-48 at % Pt) | YN | 5 | 0.1 | 7 | (Fe-49 at % Pt)- | Good | Good | 8.7 | 38.0 |
| 20 | | | | | | 40 vol % hBN | | | | |
| Example | (Fe-48 at % Pt) | YN | 5 | 0.5 | 7 | (Fe-49 at % Pt)- | Good | Good | 8.7 | 35.2 |
| 21 | | | | | | 40 vol % hBN | | | | |
| Example | (Fe-48 at % Pt) | YN | 5 | 0.7 | 7 | (Fe-49 at % Pt)- | Good | Good | 8.9 | 35.2 |
| 22 | | | | | | 40 vol % hBN | | | | |
| Example | (Fe-48 at % Pt) | TiN | 0 | 0.2 | 7 | (Fe-49 at % Pt)- | Good | Good | 8.7 | 32.9 |
| 23 | | | | | | 40 vol % hBN | | | | |
| Example | (Fe-48 at % Pt) | TiN | 0 | 0.4 | 7 | (Fe-49 at % Pt)- | Good | Good | 8.9 | 33.3 |
| 24 | | | | | | 40 vol % hBN | | | | |
| Example | (Fe-48 at % Pt) | TiN | 2.5 | 0.2 | 7 | (Fe-49 at % Pt)- | Good | Good | 8.6 | 33.4 |
| 25 | | | | | | 40 vol % hBN | | | | |
| Example | (Fe-48 at % Pt) | TiN | 2.5 | 0.4 | 7 | (Fe-49 at % Pt)- | Good | Good | 8.8 | 35.0 |
| 26 | | | | | | 40 vol % hBN | | | | |

TABLE 3

| | | | | | | | Characteristics of Magnetic Recording Medium | | | |
|---|---|---|---|---|---|---|---|---|---|---|
| | | | | | | | Coating State | | Center | |
| | | | | | | | of (111) Plane | | Distance | |
| | | | | | | | of Magnetic | | Between | |
| | 1^{st} Magnetic Layer | | | | | | Particle in 1^{st} | | Magnetic | |
| | | Coating Conditions | | | | 2^{nd} | Magnetic Layer by | | Particles | |
| | | | Gas | Film | Etching | Magnetic | Layer of Alloy | | in 1^{st} | |
| | | | Atmosphere | Thickness | Power | Layer | (VN, Si₃N₄, | hBN | Magnetic | Hc |
| | Composition | Coating | (N₂)[Pa] | [nm] | [W] | Composition | YN, or TiN) | Peak | Layer [nm] | [kOe] |
| Compar- | (Fe-48 at % Pt) | No | No | 0 | 10 | (Fe-49 at % Pt)- | No Coating | Good | 9.1 | 30.9 |
| ative | | | | | | 40 vol % hBN | | | | |
| Example 1 | | | | | | | | | | |
| Compar- | (Fe-48 at % Pt) | VN | 0 | 0.8 | 7 | (Fe-49 at % Pt)- | (001) Plane is | Good | 10.9 | 36.1 |
| ative | | | | | | 40 vol % hBN | Also Coated | | | |
| Example 2 | | | | | | | | | | |
| Compar- | (Fe-48 at % Pt) | VN | 0 | 1.4 | 7 | (Fe-49 at % Pt)- | (001) Plane is | Good | 9.3 | 24.2 |
| ative | | | | | | 40 vol % hBN | Also Coated | | | |
| Example 3 | | | | | | | | | | |
| Compar- | (Fe-48 at % Pt) | VN | 0 | 0.2 | 0 | (Fe-49 at % Pt)- | (001) Plane is | Bad | 9.4 | 33.3 |
| ative | | | | | | 40 vol % hBN | Also Coated | | | |
| Example 4 | | | | | | | | | | |
| Compar- | (Fe-48 at % Pt) | VN | 0 | 0.2 | 30 | (Fe-49 at % Pt)- | No Coating | Bad | 9.1 | 27.9 |
| ative | | | | | | 40 vol % hBN | | | | |
| Example 5 | | | | | | | | | | |
| Compar- | (Fe-48 at % Pt) | SigN4 | 0 | 0.8 | 7 | (Fe-49 at % Pt)- | (001) Plane is | Good | 9.5 | 19.2 |
| ative | | | | | | 40 vol % hBN | Also Coated | | | |
| Example 6 | | | | | | | | | | |
| Compar- | (Fe-48 at % Pt) | Si3N4 | 0 | 1.8 | 7 | (Fe-49 at % Pt)- | (001) Plane is | Good | 9.6 | 9.3 |
| ative | | | | | | 40 vol % hBN | Also Coated | | | |
| Example 7 | | | | | | | | | | |
| Compar- | (Fe-48 at % Pt) | YN | 0 | 0.8 | 7 | (Fe-49 at % Pt)- | (001) Plane is | Good | 10.5 | 36.5 |
| ative | | | | | | 40 vol % hBN | Also Coated | | | |
| Example 8 | | | | | | | | | | |
| Compar- | (Fe-48 at % Pt) | YN | 0 | 1.6 | 7 | (Fe-49 at % Pt)- | (001) Plane is | Good | 9.7 | 27.8 |
| ative | | | | | | 40 vol % hBN | Also Coated | | | |
| Example 9 | | | | | | | | | | |
| Compar- | (Fe-48 at % Pt) | TIN | 0 | 0.9 | 7 | (Fe-49 at % Pt)- | (001) Plane is | Good | 9.2 | 22.4 |
| ative | | | | | | 40 vol % hBN | Also Coated | | | |
| Example 10 | | | | | | | | | | |
| Compar- | (Fe-48 at % Pt) | TIN | 0 | 1.7 | 7 | (Fe-49 at % Pt)- | (001) Plane is | Good | 9.3 | 22.9 |
| ative | | | | | | 40 vol % hBN | Also Coated | | | |
| Example 11 | | | | | | | | | | |
| Compar- | (Fe-48 at % Pt) | SiO2 | 0 | 0.2 | 0 | (Fe-49 at % Pt)- | Coating Film Quality | Bad | 7.6 | 6.8 |
| ative | | | | | | 40 vol % hBN | is Deteriorated | | | |
| Example 12 | | | | | | | | | | |

From Tables 1 to 3, it was verified that the magnetic recording medium of each Example had better crystallinity of the hexagonal boron nitride of the first magnetic layer than the magnetic recording medium of each Comparative Example, and could exhibit a coercive force Hc of 32 kOe or more even when the center distance between the magnetic particles of the first magnetic layer was 9.0 nm or less. Moreover, in Comparative Examples 2 and 8, among Comparative Examples, the center distance between the magnetic particles of the first magnetic layer was 10.5 nm or more, which made it impossible to reduce a bit size of the magnetic recording medium, and thus the areal density of the magnetic recording medium could not be increased.

Thus, it was verified that if the (111) plane of the magnetic particles of the first magnetic layer is coated with a layer of the alloy of VN, Si₃N₄, YN, or TiN, the first magnetic layer can function as a granular magnetic layer while maintaining a state in which a granular structure is formed inside the first magnetic layer and the second magnetic layer even if the particle sizes of the magnetic particles included in the first magnetic layer and the second magnetic layer are small, and the areal density can be further improved. Therefore, since the magnetic recording medium of each embodiment has a high areal density, it can be said that it can have a high recording capacity when used in a magnetic storage device.

What is claimed is:

1. A magnetic recording medium comprising, in a following order:
a substrate;
an underlayer;
a first magnetic layer; and
a second magnetic layer, wherein:
the first magnetic layer includes a magnetic particle having an L1₀ structure;
the second magnetic layer has a granular structure including:
a magnetic particle having an L1₀ structure; and
a grain boundary including hexagonal boron nitride;
a (111) plane of the magnetic particle included in the first magnetic layer is covered with an alloy of VN, Si₃N₄, YN, or TiN at an interface with the second magnetic layer;
the magnetic particle included in the second magnetic layer epitaxially grows from a (001) plane of the magnetic particle included in the first magnetic layer; and
the magnetic particle included in the first magnetic layer and the magnetic particle included in the second magnetic layer are columnar crystals that penetrate the first magnetic layer and the second magnetic layer, respectively.

2. The magnetic recording medium according to claim 1, wherein the magnetic particle having the L1₀ structure included in the first magnetic layer and the magnetic particle having the L1₀ structure included in the second magnetic layer are FePt alloy particles.

3. A method of manufacturing a magnetic recording medium, the magnetic recording medium including, in a following order, a substrate, an underlayer, a first magnetic layer, and a second magnetic layer, wherein:
the first magnetic layer includes a magnetic particle having an L1₀ structure;
the second magnetic layer has a granular structure including:
a magnetic particle having an L1₀ structure; and
a grain boundary including hexagonal boron nitride;
a (111) plane of the magnetic particle included in the first magnetic layer is covered with an alloy of VN, Si₃N₄, YN, or TiN at an interface with the second magnetic layer;
the magnetic particle included in the second magnetic layer epitaxially grows from a (001) plane of the magnetic particle included in the first magnetic layer; and
the magnetic particle included in the first magnetic layer and the magnetic particle included in the second magnetic layer are columnar crystals that penetrate the first magnetic layer and the second magnetic layer, respectively,
the method comprising:
forming the first magnetic layer by sputtering;
forming the second magnetic layer by sputtering; and
forming, by sputtering, an alloy layer of VN, Si₃N₄, YN, or TiN between the forming the first magnetic layer and the forming the second magnetic layer.

4. A magnetic storage device comprising a magnetic recording medium, the magnetic recording medium including, in a following order, a substrate, an underlayer, a first magnetic layer, and a second magnetic layer, wherein:
the first magnetic layer includes a magnetic particle having an L1₀ structure;
the magnetic layer has a granular structure including:
a magnetic particle having an L1₀ structure; and
a grain boundary including hexagonal boron nitride;
a (111) plane of the magnetic particle included in the first magnetic layer is covered with an alloy of VN, Si₃N₄, YN, or TiN at an interface with the second magnetic layer;
the magnetic particle included in the second magnetic layer epitaxially grows from a (001) plane of the magnetic particle included in the first magnetic layer; and
the magnetic particle included in the first magnetic layer and the magnetic particle included in the second magnetic layer are columnar crystals that penetrate the first magnetic layer and the second magnetic layer, respectively.
